(19) United States
(12) Patent Application Publication
(10) Pub. No.: US 2007/0080064 A1
(43) Pub. Date: Apr. 12, 2007

(54) Micro-loading device

(75) Inventors: Michael W. Swank, Houston, TX (US); Gang-Yi Wu, Pearland, TX (US)

Correspondence Address: CONLEY ROSE, P.C., P. O. BOX 3267, HOUSTON, TX, 77253-3267, US

(73) Assignee: Baylor College of Medicine, Houston, TX (US)

(21) Appl. No.: 11/248,401

(22) Filed: Oct. 12, 2005

(51) Int. Cl. G01N 27/00

(52) U.S. Cl. 204/606

(57) ABSTRACT

An electrophoresis gel sample loader and method for making the same is disclosed. One embodiment includes the electrophoresis gel sample loader comprising a loader having a backing material and a plurality of porous sample holders mounted on the backing material. The porous sample holders retain a sample by absorption. In addition, the electrophoresis gel sample loader further includes a mounting layer comprising a plurality of dividers. At least one divider is disposed laterally to a porous sample holder.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to the field of laboratory testing of biological samples and more specifically to the field of gel electrophoresis.

2. Background of the Invention

Sodium Dodecyl Sulfate-Polyacrylamide Gel Electrophoresis (“SDS-PAGE”) is a common laboratory technique in the biomedical and life sciences. SDS-PAGE is typically used to resolve proteins in biological samples according to their size. In the most common procedure for applying SDS-PAGE, proteins from cells, tissue, or other biological samples may be prepared in a buffer containing the anionic detergent sodium dodecyl sulfate (SDS) along with a reducing agent such as β-mercaptoethanol or dithiothreitol. The molar ratio of the negatively-charged SDS to protein may be about the same for proteins of different molecular weights. Therefore, a driving force for vertical resolution may be the size-dependent rate of migration through the porous polyacrylamide gel (e.g., smaller molecular weight proteins may migrate faster in the gel and larger proteins migrate slower in the gel).

SDS-PAGE may be followed by Western blotting for detection of specific protein species. Western blotting may involve electrophoretically transferring proteins that have been resolved in the gel to a thin membrane (e.g., blot), which may be probed with antibodies to proteins of interest. Radiolabelled antibodies have been used for detection of proteins on the blot. Chemiluminescent detection has also been used for detection of the proteins. Drawbacks include a minimum amount of sample that may be loaded onto the gel in order to detect less abundant proteins. Such a drawback may be a problem for a particularly rare or difficult to obtain sample. For instance, cultured neurons, micro-punched regions of the brain, laser captured micro-dissection samples, forensic evidence, and archived human tissue may be difficult or expensive to obtain or produce. Consequently, it may be desirable to stretch the sample as far as possible. The size of the mini-gels is also a drawback, and thus a reduction in size may be advantageous. For instance, smaller lanes may allow less sample to be loaded per lane. In addition, smaller lanes may allow more samples to be loaded per gel, which may result in fewer gels per experiment, cost savings from reduced reagent consumption, and increased throughput.

Consequently, there is a need for an improved apparatus and method for electrophoretic processing of samples. In addition, there is a need for an improved loader device for samples. Further needs include a loader device that uses reduced amounts of sample.

### BRIEF SUMMARY OF SOME OF THE PREFERRED EMBODIMENTS

These and other needs in the art are addressed in one embodiment by an electrophoresis gel sample loader. The electrophoresis gel sample loader comprises a backing material. In addition, the electrophoresis gel sample loader further comprises a porous sample holder mounted on the backing material, wherein the porous sample holder retains a sample by absorption.

In another embodiment, these and other needs in the art are addressed by an electrophoresis gel sample loader. In one embodiment, the electrophoresis gel sample loader comprises a loader having a backing material and a plurality of porous sample holders mounted on the backing material. The porous sample holders may retain a sample by absorption. In addition, the electrophoresis gel sample loader further includes a mounting layer comprising a plurality of dividers, wherein at least one divider is disposed laterally to a porous sample holder.

A further embodiment addresses these and other needs in the art by a method of making an electrophoresis gel sample loader. The method includes securing a plurality of porous sample holders to a backing material to form a loader. In addition, the method includes providing a mounting layer comprising a plurality of dividers. The method further includes mounting the mounting layer to the loader to form the electrophoresis gel sample loader.

An additional embodiment overcomes these and other needs in the art by a method of making an electrophoresis gel sample loader. The method includes adhering a barrier plate to a porous sample holder to provide a stack. The method also includes cutting the stack to provide a slice, wherein the slice comprises a portion of the porous sample holder and at least a portion of the barrier plate. In addition, the method includes adhering the slice to a backing material to provide the electrophoresis gel sample loader.

The electrophoresis gel sample loader overcomes problems with conventional loading devices (e.g., 15 lane mini-loaders). For instance, the electrophoresis gel sample loader may allow for more lanes. In addition, the electrophoresis gel sample loader may allow for reduced amounts of sample to be used.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an electrophoresis gel sample loader;

FIG. 2 illustrates an exploded view as shown on FIG. 1;

FIG. 3 illustrates an embodiment with at least a portion of electrophoresis gel sample loader covered by a film;

FIG. 4 illustrates an embodiment of FIG. 3 in which the film has apertures;

FIG. 5 illustrates a rear view of an electrophoresis gel sample loader having apertures;

FIG. 6 illustrates a porous sample holder mounted on a backing with a mesh;

FIG. 7 illustrates an electrophoresis gel sample holder having barrier plates;

FIG. 8 illustrates a stacking of barrier plates and porous sample holders;

FIG. 9 illustrates cutting slices from the stacking of FIG. 8;

FIG. 10 illustrates adhering the slice of FIG. 9 to a backing;

FIG. 11 illustrates an electrophoresis gel sample loader having a film and porous strips;

FIG. 12 illustrates a mounting layer and loading of a loader;

FIG. 13 illustrates mounting the mounting layer to the loader of FIG. 12;

FIG. 14 illustrates an electrophoresis gel sample loader comprising the loader and mounting layer as illustrated in FIGS. 12 and 13;

FIG. 15 illustrates a hinged holder for preparing an electrophoresis gel sample loader;

FIG. 16 illustrates an electrophoresis gel area;

FIG. 17 illustrates a comparison of a 15-lane mini-gel to a 30-lane micro-gel for a 3 minute exposure;

FIG. 18 illustrates a comparison of a 15-lane min-gel and a 30-lane micro-gel for a 1-30 minute exposure;

FIG. 19 illustrates a densitometric quantification;

FIG. 20 illustrates a comparison of the variability of a 30-lane system to the 15-lane system;

FIG. 21 illustrates loading of sub-microgram quantities of protein to 50-lane systems;

FIG. 22 illustrates blots probed with antibodies;

FIG. 23 illustrates resolution for 10 mm lanes and 300 mm lanes for pAkt and ppERK;

FIG. 24 illustrates band width as a function of spacer composition; and

FIG. 25 illustrates band width.

### DETAILED DESCRIPTION OF THE PREFERRED EMBODIMENTS

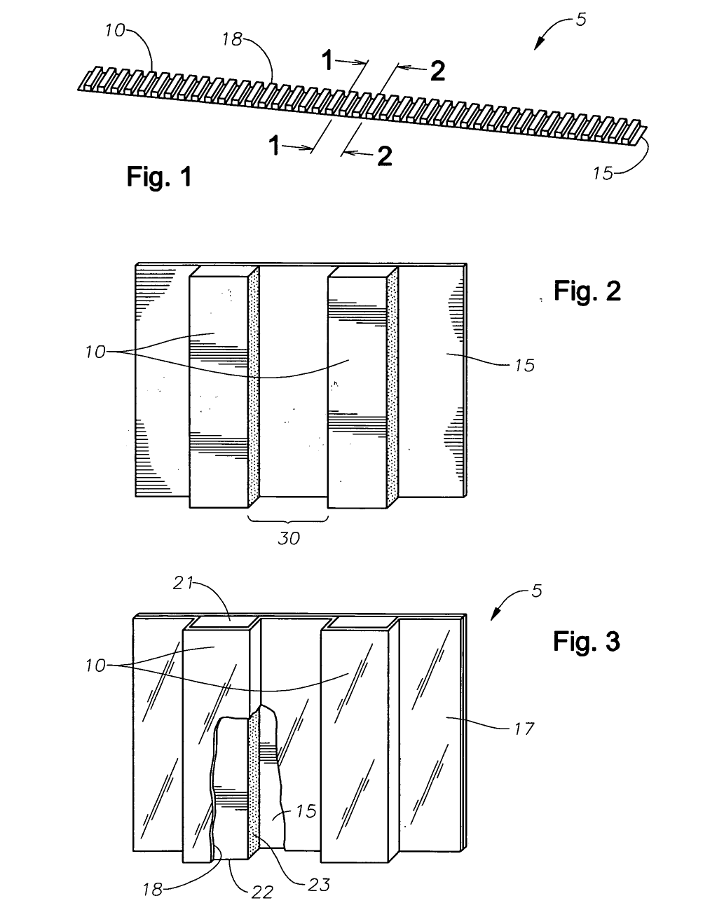

FIG. 1 illustrates an electrophoresis gel sample loader 5 having a plurality of porous sample holders 10 and a backing 15. Porous sample holders 10 are mounted on backing 15. Porous sample holders 10 may be mounted on backing 15 by any suitable method. An example of a suitable method is using an adhesive to mount porous sample holders 10. Without limitation, examples of suitable adhesives include glue, tape, and the like. For instance, a tape having two adhesive sides may be used, with one side secured to backing 15 and the other side secured to porous sample holder 10. Porous sample holder 10 may comprise any material that may absorb a sample. Without limitation, examples of suitable absorbent materials include cotton cellulose fibers, sponge material, filter paper, foam, immobilized syntactics, hollow tubes (e.g., oriented capillary tubes), or combinations thereof. Without being limited by theory, the sample may be retained in porous sample holder 10 by absorption (e.g., capillary action). In an alternative embodiment, porous sample holder 10 may be chemically modified. Porous sample holder 10 may be chemically modified for any desirable purpose. In an embodiment, porous sample holder 10 may be chemically modified to bind a targeted substance or substances in the sample. For instance, substances such as albumin or DNA may be targeted and chemically bound to not migrate from porous sample holder 10 when loaded in a gel. In an embodiment, the chemical modification is accomplished by adding a chemical that may target and bind the desired substance and not the protein in the sample, with the substance retained in porous sample holder 10 when loaded in a gel. In one embodiment, porous sample holder 10 may be chemically modified with DNase, which may destroy DNA. Electrophoresis gel sample loader 5 may comprise any suitable number of porous sample holders 10. In an embodiment, electrophoresis gel sample loader 5 may comprise from about 10 to about 100 porous sample holders 10, alternatively from about 15 to about 50 porous sample holders 10, and alternatively from about 30 to about 50 porous sample holders 10.

As further illustrated in FIG. 1, backing 15 may be any material that does not react with the sample and porous sample holder 10 and that is suitable for providing support to porous sample holder 10. Without limitation, examples of suitable materials of which backing 15 may be comprised include plastic, glass, polymeric material, and the like. Backing 15 may have any desired flexibility. In an embodiment, backing 15 may have a flexibility that is semi-rigid or substantially rigid. Without being limited by theory, backing 15 may substantially prevent migration of the sample in the direction of backing 15 when loaded in a gel.

FIG. 2 illustrates an exploded view taken between lines 1-1 and 2-2 of FIG. 1 and shows a porous sample holder 10 with backing 15. Porous sample holder 10 may have any length and depth suitable for absorbing a sufficient amount of sample for a desired use.

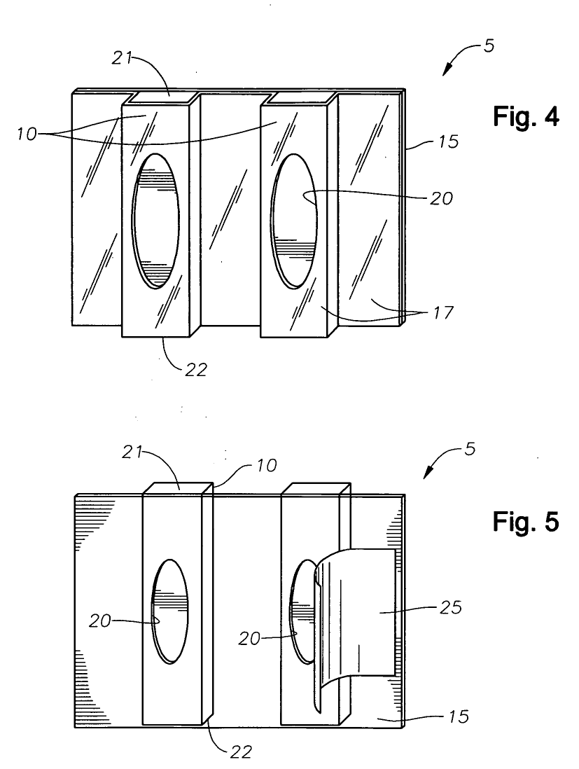

In an embodiment as shown in FIG. 3, a film 17 is applied to electrophoresis gel sample loader 5. As shown in FIG. 3, film 17 may be sufficiently applied to cover at least a portion of each porous sample holder 10 and/or at least a portion of backing 15. It is to be understood that reference 18 is for illustration purposes only and shows a cut away portion of film 17 to illustrate film 17 covering the underlying porous sample holders 10 and backing 15. It is therefore to be understood that in embodiments electrophoresis gel sample loader 5 does not comprise reference 18. Ends 21 and 22 of porous sample holder 10 are not covered by film 17. The sample may be loaded at ends 21 and 22. Without being limited by theory, lateral diffusion/migration of the samples from the sides 23 of porous sample holders 10 may be reduced by film 17. Porous sample holder 10 may be covered with a film 17 that substantially prevents passive diffusion/undesired migration of a sample from porous sample holder 10. Without limitation, examples of suitable films 17 include plastic films and other thin non-permeable barrier materials. In an alternative embodiment as shown in FIG. 4, film 17 has apertures 20. Apertures 20 provide an exposed portion of porous sample holder 10. As shown in FIG. 4, an aperture 20 is provided for each porous sample holder 10. In alternative embodiments (not illustrated), more than one aperture 20 may be provided for each porous sample holder 10, which provides additional exposure of porous sample holder 10. Apertures 20 may be provided in film 17 by any suitable method. The sample may be loaded to porous sample holders 10 through end 21, end 22, and/or aperture 20. In an embodiment (not illustrated), an aperture 20 is covered by one or more barriers, which are substantially similar to barriers 25 illustrated in FIG. 5.

FIG. 5 illustrates a rear view of an embodiment of electrophoresis gel sample loader 5 in which backing 15 has apertures 20. Apertures 20 may be of any suitable size and configuration to expose a portion of porous sample holder 10. The sample may be loaded via apertures 20. Electrophoresis gel sample loader 5 may also comprise a barrier 25. Barrier 25 may be any material suitable for covering aperture 20 and substantially preventing migration of the sample protein in the direction of barrier 25. Without limitation, examples of suitable barriers 25 include tape, film, plastic sheets, and membranes. For instance, as shown in FIG. 5, barrier 25 may be a tape that is applied to the rear side of backing 15. In an embodiment, barrier 25 covers all or a portion of apertures 20. It is to be understood that any suitable barrier 25 may be used to cover apertures 20. In such an embodiment, film 17 covers all of porous sample holder 10 except for ends 21 and 22, which are not covered by film 17. For instance, in an alternative embodiment (not illustrated), one barrier 25 may cover all apertures 20. In an alternative embodiment (not illustrated), film 17 and backing 15 may each comprise at least one aperture 20.

In an embodiment, the sample may comprise any material suitable for analysis in polyacrylamide gel electrophoresis. Without limitation, examples of suitable samples include protein, deoxyribonucleic acid (DNA), and ribonucleic acid (RNA). The sample may be loaded to electrophoresis gel sample loader 5 by any suitable method. For instance, a pipette may be used to load the sample. In an embodiment, a plurality of porous sample holders 10 are simultaneously loaded. For instance, a multi-channel pipette may be used to load the sample.

Electrophoresis gel sample loader 5 may be made by any suitable method. In an embodiment, material for porous sample holder 10 (e.g., filter paper strips) may be mounted on material for backing 15 (e.g., mounted on a plastic backing sheet). Porous sample holder 10 is mounted on backing 15 with a suitable adhesive such as double-sided adhesive tape. For instance, filter paper sheets may be loaded onto a suitable cutting device. Without limitation, an example of a suitable cutting device is a guillotine-type paper cutter. The cutting device cuts the filter paper at the desired width. The filter paper may be advanced through the cutting device manually or by use of a device. For instance, a device such as a linear micromanipulator may be mounted on the cutter surface and used to automatically advance the filter paper after each cut. The filter paper may be cut to any desired width. In one embodiment, the filter paper is cut into strips to provide porous sample holders 10 of from about 0.4 mm to about 1.1 mm in width, alternatively from about 0.4 mm to about 0.6 mm in width. It is to be understood that porous sample holder 10 is not limited to such widths but may have any desired width suitable for use in gel electrophoresis. Electrophoresis gel sample loader 5 may have porous sample holders 10 spaced apart by any suitable distance. For illustration purposes, FIG. 2 illustrates one such gap 30 showing the distance porous substrates 10 are spaced apart. Without limitation, such gaps 30 may be from about 0.25 mm to about 1.5 mm. For example, an electrophoresis gel sample loader 5 having porous sample holders 10 that are 1 mm wide and 1 mm thick and separated by a 1.5 mm gap 30 may have 30 lanes (e.g., porous sample holders 10) per 8 cm wide mini-gel. The desired spacing of gaps 30 between porous sample holders 10 may be achieved by any suitable method. In one embodiment, spacers such as plastic strips of the desired width may be disposed between porous sample holders 10 on a surface in such a manner that each porous sample holder 10 may be separated from another porous sample holder 10 by a spacer. A backing 15 with adhesive may then be applied, which may allow porous sample holders 10 and spacers to be adhered to backing 15. The spacers may then be removed by any suitable method (e.g., pealing away the spacers). In some embodiments, adhesive disposed on backing 15 may be exposed by removal of the spacers. The resulting electrophoresis gel sample loader 5 may then be cut to any desired size. For instance, an electrophoresis gel sample loader 5 having 60 porous sample holders 10 of 10 cm length may be cut in half between the middle two porous sample holders 10 to provide two 30-lane loaders (e.g., electrophoresis gel sample loaders 5 each having 30 porous sample holders 10). It is to be understood that the length may be variable to suit the volume of sample. It is to be further understood that the loading capacity of each porous sample holder 10 may depend upon factors such as width and length of porous sample holder 10 as well as the material comprising porous sample holder 10. In an embodiment, perforations may be provided in backing 15, which may allow electrophoresis gel sample loader 5 to be reduced in size (e.g., by applying pressure to the perforations for separation).

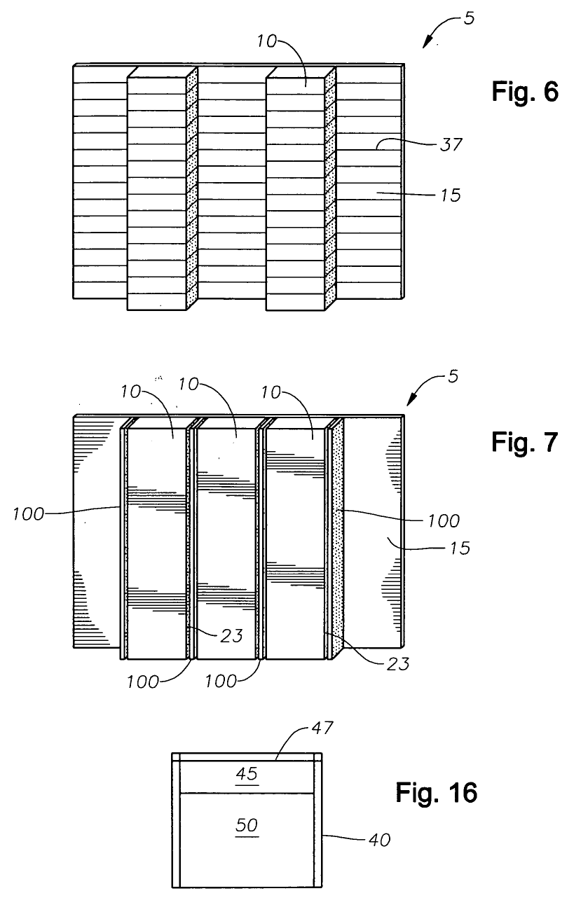

In an alternative embodiment, porous sample holder 10 may be mounted on backing 15 with a mesh and/or linear fibers. FIG. 6 illustrates an embodiment wherein porous sample holder 10 is mounted with a mesh 37. Mesh 37 may be applied across at least a portion of porous sample holder 10 and secured to electrophoresis gel sample loader 5 by any suitable method such as using glue, tacks, staples, and the like. The secured mesh 37 provides sufficient force to porous sample holder 10 to substantially hold porous sample holder 10 in place on backing 15. Mesh 37 may have a suitable porosity to allow loading of the sample through mesh 37. Mesh 37 may be applied to substantially all or a portion of porous sample holder 10. In alternative embodiments (not illustrated), solid strips may be used to secure porous sample holder 10 to backing 15. The strips may comprise any suitable material for use in gel electrophoresis such as, without limitation, plastic, cloth, and the like.

FIG. 7 illustrates an embodiment in which electrophoresis gel sample loader 5 comprises barrier plates 100. Barrier plates 100 may comprise any substantially rigid material. Without limitation, examples of suitable materials include plastic, glass, and the like. In an embodiment, barrier plates 100 comprise substantially rigid plastic. Without being limited by theory, barrier plates 100 may reduce lateral diffusion/migration of sample from porous sample holders 10. Further, without being limited by theory, barrier plates 100 may provide physical support to porous sample holders 10. Barrier plates 100 may be secured to backing 15 by any suitable methods such as by glue, tape, and the like. In alternative embodiments (not illustrated), electrophoresis gel sample loader 5 does not have barrier plates 100 lateral to each side 23 of a porous sample holder 10 but instead has at least one porous sample holder 10 that does not have a barrier plate 100 lateral to at least one side 23. In some embodiments, at least one of the porous sample holders 10 is loaded with an ionic material.

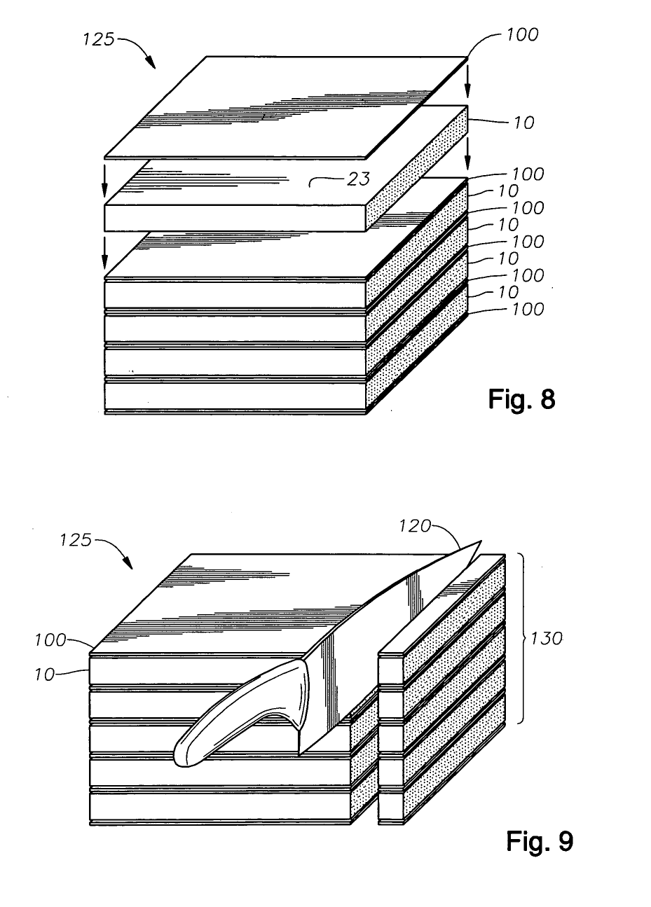

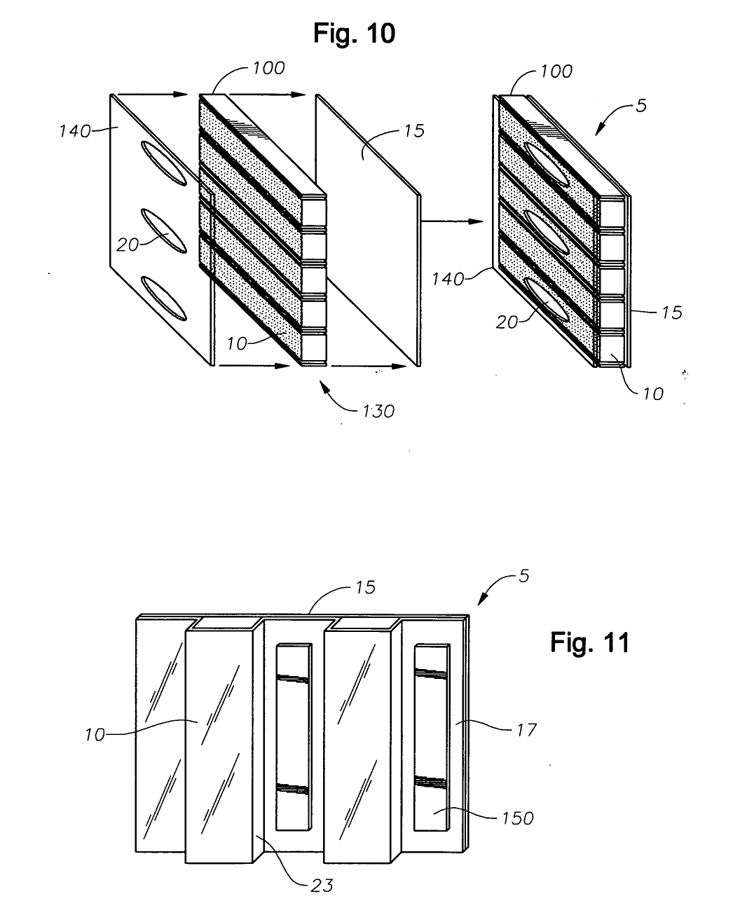

FIGS. 8-10 illustrate an embodiment of a method for preparing an electrophoresis gel sample loader 5 comprising barrier plates 100. As shown in FIG. 8, barrier plates 100 and porous sample holders 10 are stacked together horizontally with a barrier plate 100 adjacent to each side 23 of a porous sample holder 10 to provide a stack 125. In an embodiment, the amount of porous sample holders 10 stacked may correspond to the number of lanes desired in electrophoresis gel sample loader 5. In an embodiment, an adhesive may be applied to adhere each barrier plate 100 to a porous sample holder 10. FIG. 9 illustrates a cutter 120 cutting slices 130 from stack 125. Slices 130 may be any desirable thickness (e.g., 1 mm). Cutter 130 may comprise any suitable cutting device such as a knife. FIG. 10 shows adhering of slice 130 to a backing 15. Slice 130 may be adhered to backing 15 by any suitable method such as by glue. In some embodiments, a front barrier 140 may be adhered to slice 130 on the opposite side of slice 130 from backing 15. Front barrier 140 may be adhered to slice 130 by any suitable method such as by glue. Front barrier 140 has at least one aperture 20. In alternative embodiments (not illustrated), backing 15 may also have at least one aperture 20. In other alternative embodiments (not illustrated), backing 15 has at least one aperture 20, and front barrier plate 140 has no apertures 20.

In another embodiment, ionic material may be added to electrophoresis gel sample loader 5. As shown in FIG. 11, electrophoresis gel sample loader 5 may further comprise porous strips 150. Porous strips 150 may comprise any material that may absorb a fluid. Without limitation, examples of suitable materials include fibrous material, sponge material, filter paper, foam, immobilized syntactics, and hollow tubes (e.g., oriented capillary tubes). Without limitation, examples of suitable fibrous material include cotton, cellulose (e.g., derived from non-cotton sources), polyester, nylon, glass, and fibers. Porous strips 150 may be adhered to backing 15 by any suitable method such as by glue. Electrophoresis gel sample loader 5 may comprise any suitable number of porous strips 150. In an embodiment, electrophoresis gel sample loader 5 comprises a porous strip 150 lateral to each side 23 of electrophoresis gel sample loader 5. Ionic material may be loaded to porous strips 150 in any suitable amounts. The ionic material may be manually loaded to porous strips 150 or pre-loaded to porous strips 150 before or during manufacturing of electrophoresis gel sample loader 5. Without being limited by theory, the ionic material may enhance lateral resolution of the sample. In one embodiment, porous strips 150 may be smaller and thinner than porous sample holders 10. The ionic material may be any ionic material suitable for use in gel electrophoresis such as non-interfering salts (e.g., sodium chloride) and sodium dodecyl sulfate (SDS). In an alternative embodiment (not illustrated), electrophoresis gel sample loader 5 does not comprise film 17, and porous strips 150 adhere to backing 15.

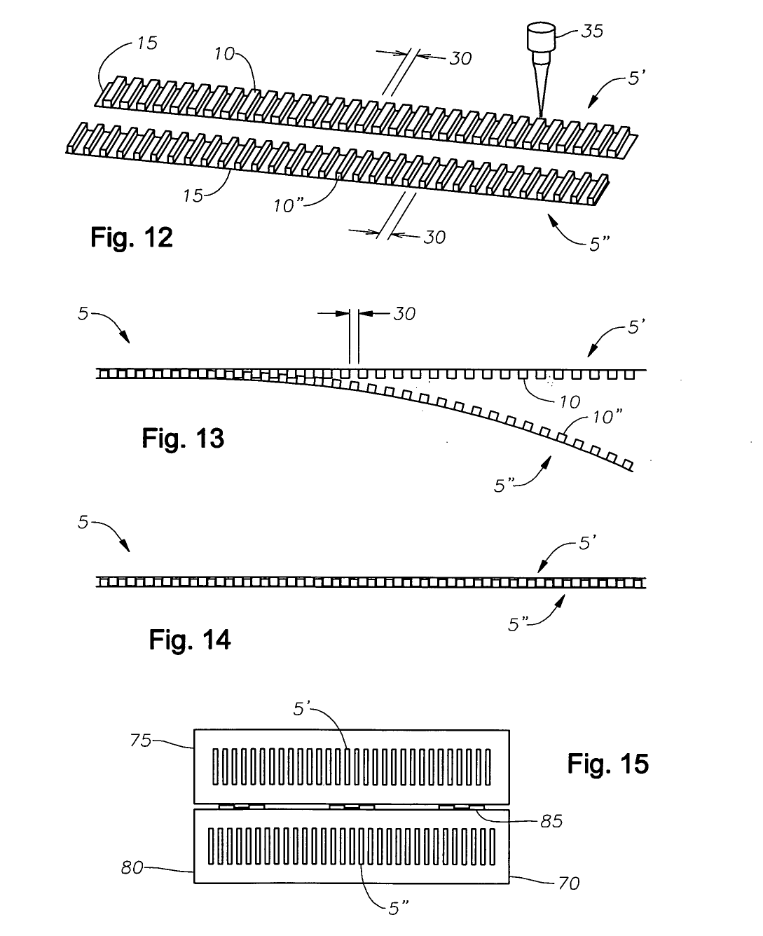

FIGS. 12-14 illustrate an embodiment in which an electrophoresis gel sample loader 5 is prepared from a loader 5′ and a mounting layer 5″. As shown in FIG. 12, loader 5′ has porous sample holders 10, which are not covered by a film 17, and backing 15. In alternative embodiments (not illustrated), a portion of at least one porous sample holder 10 of loader 5′ is covered by film 17. As further illustrated in FIG. 12, mounting layer 5″ has a backing 15 and dividers 10″. In an embodiment, mounting layer 5″ may be substantially similar to loader 5′. For instance, mounting layer 5″ may have about a similar (or about the same) divider 10″ width/length as porous sample holder 10 width/length of loader 5′ as well as gap 30 width as loader 5′. Dividers 10″ of mounting layer 5″ are at least partially covered with film 17 or not covered with film 17. Sample may be loaded on to porous sample holder 10 of loader 5′ by a pipette or by any other method. As shown in FIG. 13, loader 5′ and mounting layer 5″ may be pressed together after loading of loader 5′, with dividers 10″ of mounting layer 5″ positioned in gaps 30 between and lateral to porous sample holders 10 of loader 5′. Without being limited by theory, such a positioning may secure loader 5′ and mounting layer 5″ together. FIG. 14 illustrates electrophoresis gel sample loader 5 comprised of loader 5′ and mounting layer 5″. In an embodiment, loader 5′ may have exposed adhesive in gaps 30. In such an embodiment, the adhesive may adhere to the corresponding dividers 10″ of mounting layer 5″. Without being limited by theory, the adhesive may secure loader 5′ to mounting layer 5″. Without being limited by theory, an embodiment of electrophoresis gel sample loader 5 comprising loader 5′ and mounting layer 5″ may improve migration of a sample into a gel during gel electrophoresis. For instance, a sample may migrate in a gel under gel electrophoresis conditions to an area having favorable ionic conditions. The mounted mounting layer 5′ with dividers 10″ provide less favorable ionic conditions than the gel, which may facilitate the sample migration into the gel. Without being limited by theory, lateral migration of a sample may be altered by the ionic conditions of the region of the gel adjacent or lateral to the sample. In an embodiment, ionic material may be added to mounting layer 5″. The ionic material may be added to mounting layer 5″ in any position suitable to affect the migration direction of the sample. For instance, the ionic material may be added to dividers 10″ of mounting layer 5″. In one embodiment (not illustrated), loader 5′ and/or mounting layer 5″ may comprise porous strips 150 loaded with ionic material in a similar manner to the embodiments illustrated in FIG. 11. In an alternative embodiment, divider 10″ of mounting layer 5″ may comprise the ionic material. It is to be understood that the ionic material may be loaded by a user or pre-loaded during manufacture. In other alternative embodiments, a coating on mounting layer 5″ may comprise the ionic material and/or the ionic material may be added to the coating. Divider 10″ may comprise material suitable for absorbing and retaining a sample or any material suitable for reducing lateral migration of the sample. For instance, divider 10″ may comprise plastic. In an embodiment in which divider 10″ contains ionic material, the plastic may be sufficiently porous to retain the ionic material and to allow flow of current.

Loader 5′ and mounting layer 5″ may be pressed together to form electrophoresis gel sample loader 5 by any suitable method. In one embodiment, as illustrated in FIG. 15, a hinged holder 70 may be used to press loader 5′ and mounting layer 5″ together. Hinged holder 70 may comprise first and second sides 75, 80 that are connected by hinges 85. First and second sides 75, 80 may comprise any suitable material such as without limitation wood, plastic, and ceramic. In an embodiment, loader 5′ and mounting layer 5″ may be placed on first and second sides 75, 80, and first and second sides 75, 80 may be pressed together to form electrophoresis gel sample loader 5. In some embodiments, first and second sides 75, 80 may have slots in their surfaces in which loader 5′ and mounting layer 5″ may be placed prior to being pressed together. The slots may be sufficient in depth and length to substantially prevent loader 5′ and mounting layer 5″ from undesired moving while being pressed together.

As illustrated in FIG. 16, electrophoresis gel sample loader 5 may be loaded in a gel area 40 of a gel electrophoresis apparatus (not illustrated). Gel area 40 has a stacking gel zone 45 and a resolving gel zone 50. It is to be understood that gel area 40 is shown on FIG. 16 for illustration purposes and may have any suitable configuration for gel electrophoresis. For instance, examples of configurations include the denaturing discontinuous Laemmli method, non-denaturing gels, acid-urea gels for resolution of histones, and gels suitable for resolution of DNA or RNA. The denaturing discontinuous Laemmli method includes stacking gel zone 45 comprising a low percentage acrylamide gel, and resolving gel zone 50 comprising a higher percentage acrylamide gel. Electrophoresis gel sample loader 5 may be placed on the top surface 47 of stacking gel zone 45 with an end 21 or 22 in contact with top surface 47 of stacking gel zone 45. The gel electrophoresis may include applying a voltage across gel zones 45 and 50.

In some embodiments, electrophoresis gel sample loader 5 may be pre-loaded prior to its use in gel electrophoresis. For instance, electrophoresis gel sample loader 5 may be loaded with sample and stored (e.g., frozen) until time for its use in gel electrophoresis.

To further illustrate various illustrative embodiments of the present invention, the following examples are provided.

### EXAMPLES

In each of examples I-V, protein from rat brain was obtained. Homogenates were obtained from the brains of either control or rapamycin treated rats. Samples were prepared by dounce-homogenizing brain tissue in a hypotonic lysis buffer, with the resulting concentrated protein suspensions further diluted in lysis buffer and SDS sample buffer to a concentration of 0.5 μg/μl and boiled. Control and rapamycin samples were then loaded in an alternating fashion onto hand-cast 10% polyacrylamide gels using a MINI PROTEAN 3 system, which is commercially available from Bio-Rad Laboratories, Inc. 15-lane gels were cast using a comb to produce wells in the stacking gel, and samples were loaded into the resultant wells. 30-lane gels were cast with a flat stacking gel, and samples were loaded using 30-lane micro-loading devices.

SDS-Page and Western Blotting

After electrophoresis, all gels from each experiment were transferred to a single sheet of polyvinylidene fluoride (PVDF) and probed simultaneously with antibodies to phospho-Akt (pAkt, pS473, 1/1000), dually phosphorylated ERK (ppERK, 1/2000), and PHOSPHO-S6 (pS6, 1/3000), all from Cell Signaling, and diluted in 2% milk/TTBS. TTBS refers to tris-buffered saline with 0.05% of TWEEN-20, which is commercially available form ICI Americas Inc. After incubation overnight at 4°, blots were rinsed in TTBS for 30 minutes and incubated in 2° antibodies (HRP-conjugated goat anti-mouse and anti-rabbit, 1/20,000, in 5% milk/TTBS) for 1 hr. Following a 30-minute rinse in TTS, blots were incubated in chemiluminescent substrate (SUPERSIGNAL PICO WEST supplemented with 5% SUPERSIGNAL FEMTO, which are commercially available form Pierce Biotechnology, Inc.) and exposed to film.

### Example I

For this experiment, 1, 2, 4, or 8 μg of protein per lane were loaded across each gel, resulting in 4 gels for the 15-lane system, and 4 gels for the 30-lane system. The gels were 1.5 mm thick, 8 cm wide, and 6 cm high. SDS-PAGE was performed as described, and all 8 gels were transferred to a single large piece of PVDF transfer membrane. Following western blotting, the blot was exposed to film for 0.3, 1, 3, 10, and 30 minutes, and densitometry was performed to quantitatively measure the signal obtained for the phosphorylated forms of the protein kinases (pAkt), ERK (ppERK), and the ribosomal protein S6 (pS6).

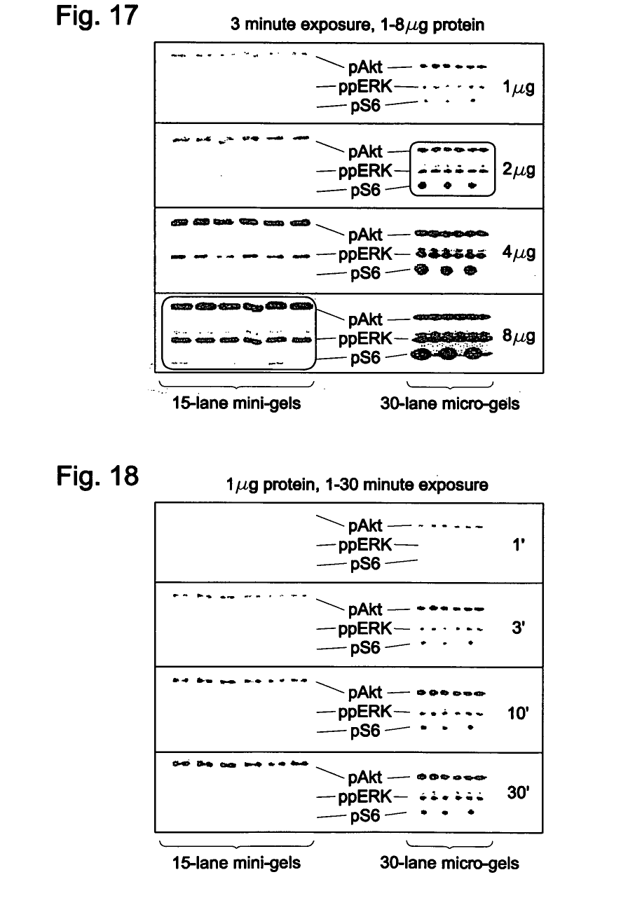

FIGS. 17 and 18 show the results of the comparison between the conventional 15-lane mini-gel and the 30-lane micro-gel system. The blots obtained from the 30-lane micro-gels have excellent resolution, and for any given protein amount, have signal intensities per unit area greater than the 15-lane system. FIG. 17 shows a composite of signals obtained from 1-8 μg protein following a 3-minute exposure. For each protein load, the signal obtained from the 30-lane system is far greater than that obtained from the 15-lane system, and in general, a similar or greater signal intensity is obtained with far less protein in the 30-lane system. Compare, for example, the signal obtained from the 2 μg/30-lane micro-gel with the 8 μg/15-lane mini-gel. Signal intensities for pAkt and ppERK were comparable, and the 2 μg/30-lane pS6 signal was much greater than that obtained with 8 μg/15-lane. It can be seen that at this short exposure time, the signals obtained from the 4- and 8 μg/30-lane blots are saturated and appear overloaded, demonstrating that far less protein was needed with the 30-lane system.

Further comparison of the two systems can be obtained by evaluating the signal intensity of a 1 μg protein load as a function of exposure time as illustrated in FIG. 18. On the left side is the 1 μg 15-lane mini-gel signal obtained after exposure to film for between 1 to 30 minutes. Even after 30 minutes, 1 μg does not produce measurable signal for either ppERK or pS6 with the 15-lane system. In contrast, 1 μg protein loaded on a 30-lane micro-gel prep has a measurable signal for all three proteins, pAkt, ppERK, and pS6, after only 3 minutes. It is noteworthy that the concentrations of both primary and secondary antibodies have been optimized for maximum sensitivity with minimal background, and thus it would be difficult to boost the signal from 1 μg of protein loaded on the older 15-lane mini-gel system any more without increasing background or using more expensive antibody. Without being limited by theory, because the 30-lane micro-gel is more sensitive, the concentration of primary antibody may be decreased with this new system, resulting in additional cost savings over the older system. This advantage is in addition to the savings that result from the reduced volume of antibody solution needed for the smaller blots obtained with the new micro-gel system.

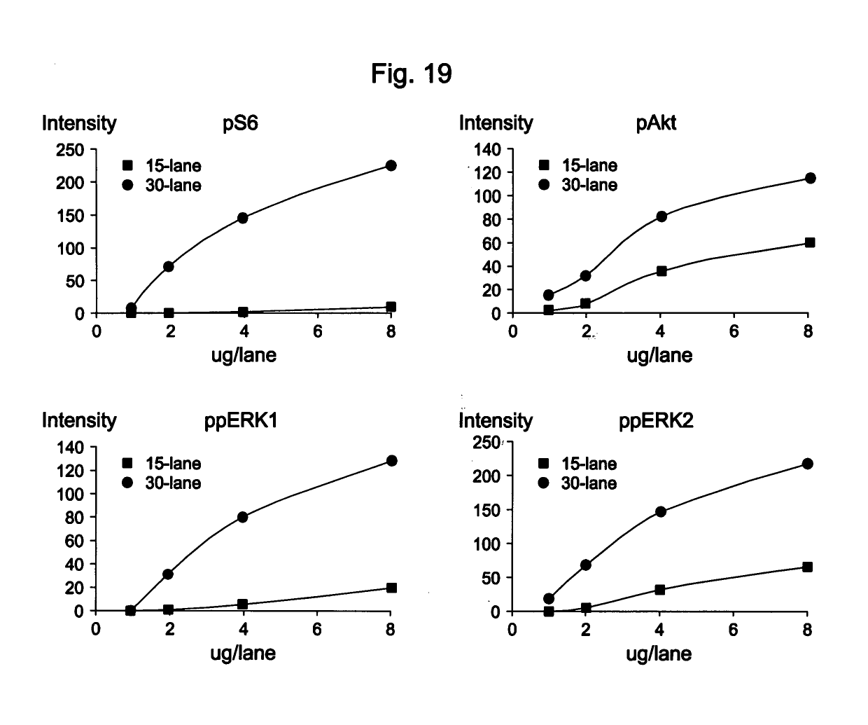

As shown in FIG. 19, densitometric quantification shows that the signal intensity obtained from the 30-lane micro-gel system is greater than that obtained with 15-lane mini-gels. Normally, the integrated optical density (IOD) is measured, which is obtained by multiplying the mean pixel intensity by the area of the band. However, this is not a fair comparison for this example, as the area of each lane in the 30-lane prep is inherently less than that of a 15-lane prep, and thus the bands are necessarily smaller in area. To account for this factor, the area of the bands obtained from a maximal signal on the 15-lane blots for each protein of interest was measured. This area was multiplied by ¼ and used to frame the bands obtained from the 30-lane systems. Within the area, mean pixel intensity was then obtained. This reduction factor was chosen because the width of the 30-lane sample lanes was roughly ½ that of the 15-lane sample lanes, and the 30-lane gels are only run ½ the vertical distance of the 15-lane gel. The result is ½×½=¼ for the predicted area of the 30-lane system relative to the 15-lane system. It is to be understood that this is just one way to compare sensitivities of the 15-lane blots with the 30-lane blots. Another comparison is to look at threshold effects for specific proteins. For example, when 1 μg of protein was loaded on the 15-lane system, ppERK and pS6 were undetectable after even a 30-minute exposure to film. In contrast, 1 μg of protein loaded on the 30-lane system resulted in measurable ppERK and pS6 after only a 3-minute exposure to film. By this measure, the 30-lane system generated a greater signal after 1/10 the exposure time, which suggests that the system is 10 times as sensitive. However, signal intensity is not a linear function of exposure time, so the sensitivity is probably somewhat less. On the other hand, even after 30 minutes, ppERK and pS6 were undetectable in the 15-lane gels loaded with 8 μg protein, whereas 1 μg generates a measurable signal in the 30-lane system, and at a reduced exposure time, which shows that the 30-lane system may be at least 8 times as sensitive. Therefore, the 30-lane system may be more sensitive than the older 15-lane system, and measurable signal may be obtained with less protein than with the older 15-lane system.

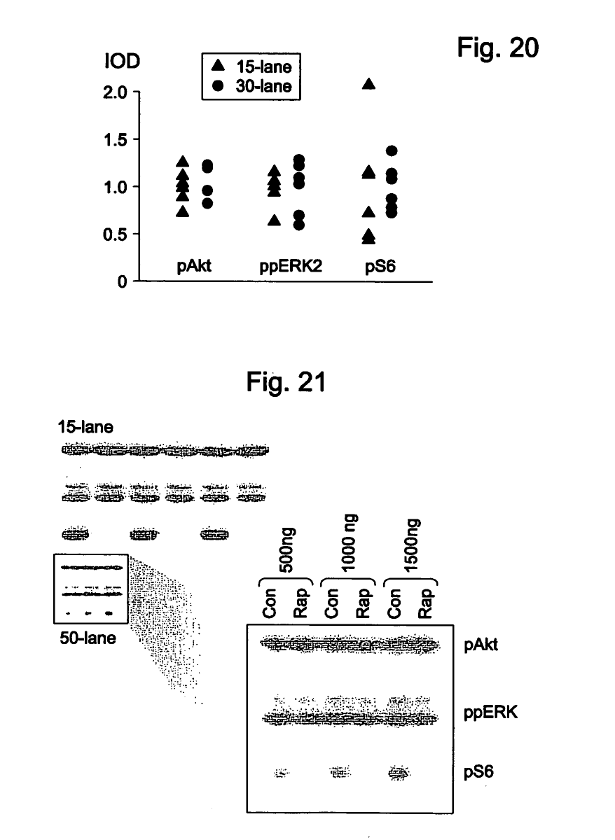

We have also determined that the variability of the 30-lane system is comparable to the 15-lane system, as shown in FIG. 20. Such a comparison shows that not only is the 30-lane system more sensitive but that it is also as reliable as the 15-lane system.

### Example II

50-lane loaders were constructed using 0.8 mm wide strips with 0.8 mm spacer widths. Strips were then loaded with either 500, 1000, or 1500 ng protein, resolved by SDS-PAGE, and blots were probed for pAkt, ppERK, and pS6 as described above.

As shown in FIG. 21, there was sufficient signal and resolution from the 500 ng load for pAkt and ppERK, which demonstrated that this system allowed for sub-microgram quantities of protein. The 500 ng used in this Example II was 40 times less protein than a typical protein load. The signal for pS6, however, was barely visible in the 500 ng lanes, which may represent a threshold effect for pS6 as pS6 was not detected in 15-lane gels when the protein load was below a certain value.

### Example III

30-lane blots loaded with 2 μg protein were probed for a number of proteins that vary in molecular weight and cellular localization. Antibodies to membrane-bound neurotransmitter receptors (GluR1, GluR2, NMDA receptor subunits NR1 and NR2B), cytoskeletal proteins (MAP2, Acetylated-α-tubulin), various protein kinases (p70S6K, pCaMKII, pRaf, GSK3β), and other proteins (TOAD-64, cadherin, synaptotagmin, NCAM) were used. Blots with antibodies were also probed to protein kinase-specific phosphorylation motifs. These antibodies recognized a variety of proteins that were phosphorylated by Akt, proline-directed kinases (pTP), PKA, and PKC. Because these antibodies recognized their respective phosphorylation motifs, they detected multiple proteins across a broad range of molecular weights.

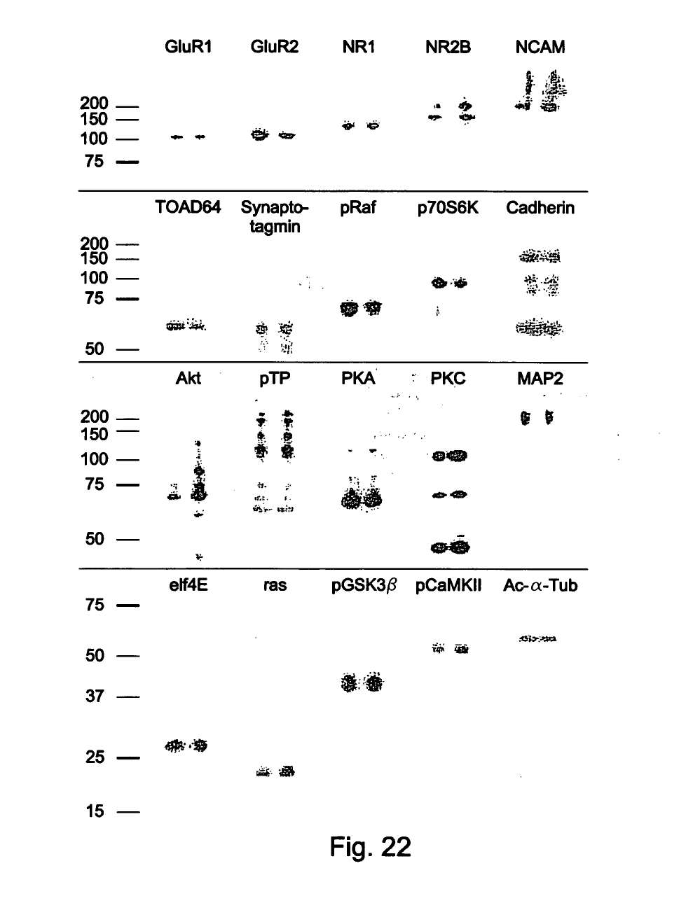

FIG. 22 shows blots probed with a variety of antibodies that have been used in the past with the 15-lane system, and in all cases, the signal and resolution were comparable using the 30-lane system. Proteins that were readily detected include membrane-bound neurotransmitter receptors (GluR1, GluR2, NMDA receptor subunits NR1 and NR2B), cytoskeletal proteins (MAP2, Acetylated-α-tubulin), protein kinases (p70S6K, pCaMKII, pRaf, GSK3β), and other structural proteins (TOAD-64, cadherin, synaptotagmin, NCAM). Blots with antibodies were also probed to protein kinase-specific phosphorylation motifs. These antibodies recognized a variety of proteins that were phosphorylated by Akt, proline-directed kinases (pTP), PKA, and PKC. Given the ability to detect both low molecular weight proteins (pS6, elF4E, p21Ras) and high molecular weight proteins (mTOR, NR2B, MAP2), the filter paper strips do not demonstrate any selective retention of proteins as a function of molecular weight. Furthermore, the proteins that were detected in these blots differ in their hydrophobicity, but all are readily detectable, suggesting again that the filter paper strips do not demonstrate any significant binding or retention of proteins due to hydrophobic interactions.

### Example IV

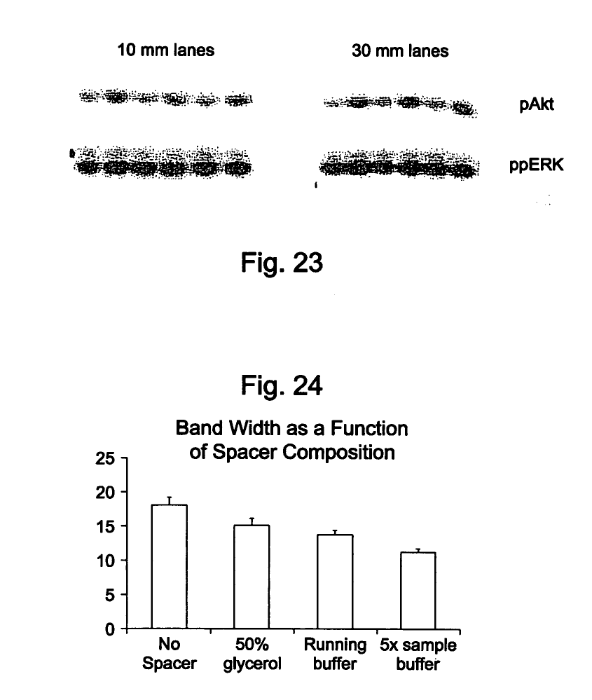

30-lane loaders were constructed with strip lengths of either 10 mm or 30 mm. The maximum loading capacity of these was 10 μl and 30 μl, respectively. Samples used above were diluted to either 0.3 μg/μl or 0.1 μg/μl. A total of 2.4 μg protein per lane was loaded onto the strips using either 8 μl of 0.3 μg/μl or 24 μl of 0.1 μg/μl protein. Blots were then probed for pAkt and ppERK. An additional test of the system was its ability to resolve large volumes of very dilute protein samples. To test whether one can load very dilute samples, 30-lane loaders were constructed with strip lengths of either 10 mm or 30 mm. The loading capacities of these were approximately 8 μl and 24 μl, respectively. Samples were loaded onto the strips using either 8 μl of 0.3 μg/μl protein or 24 μl of 0.1 μg/μl protein. As FIG. 23 shows, both strip lengths produced adequate horizontal and vertical resolution and comparable signal intensity for both proteins.

### Example V

To determine how the ionic conditions of spacer lanes affect migration of samples, four separate gels were run with the same 2 μg protein in each lane as before. In the first gel, no mounting layer was used. In the second, porous sample holders in the mounting layer were loaded with 50% glycerol in water, which has a higher electrical resistance than an empty space filled with running buffer. In the third gel, the mounting layer was saturated with running buffer, and in the fourth, the porous sample holders in the mounting layer were loaded with 5×SDS sample buffer, which has the highest ionic strength and thus the lowest resistance. Gels were run as before, and western blots were probed for pAkt, ppERK, and pS6 as before. Densitometry was performed, and band width was calculated for the pS6 signal.

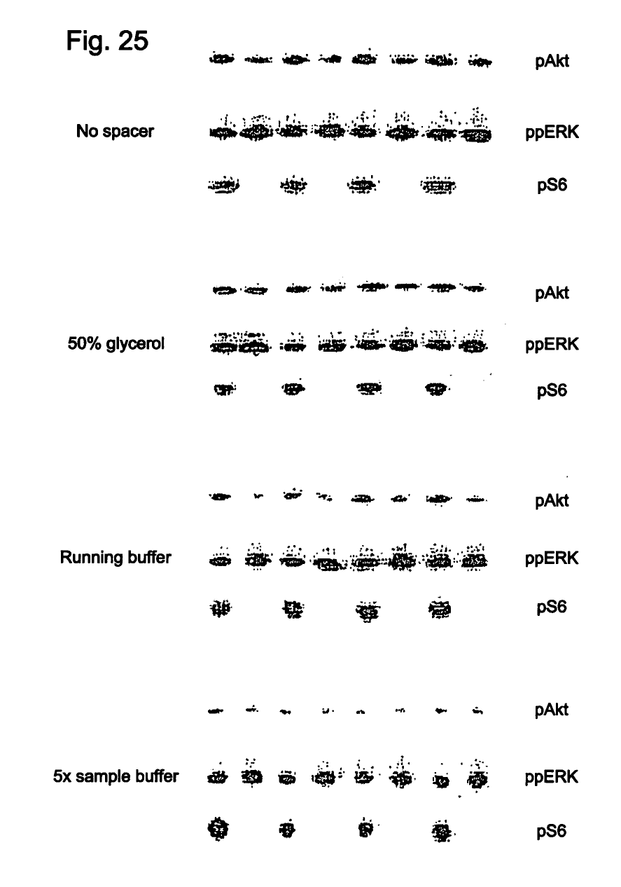

As FIGS. 24 and 25 show, there is a dramatic reduction in band width from the no spacer condition to the 5×SDS sample buffer condition. In the 5× condition, the bands were laterally compressed to the point where they were more similar to dots than bands. To generate a fair comparison between all four conditions, gels were run simultaneously for the same length of time, equilibrated in transfer buffer for the same length of time, and transferred together onto a single PVDF membrane. For the gel with 5× sample buffer in the mounting layer, a longer equilibration in transfer buffer prior to transfer may wash out more of the SDS and produce a better transfer with greater retention of Akt.

Although the present invention and its advantages have been described in detail, it should be understood that various changes, substitutions and alterations may be made herein without departing from the spirit and scope of the invention as defined by the appended claims.

What is claimed is:

1. An electrophoresis gel sample loader, comprising:
a backing material; and a porous sample holder mounted on the backing material, wherein the porous sample holder retains a sample by absorption.

2. The electrophoresis gel sample loader of claim 1, wherein the porous sample holder comprises fibrous material, sponge material, filter paper, foam, immobilized syntactics, hollow tubes, or combinations thereof.

3. The electrophoresis gel sample loader of claim 1, wherein the porous sample holder is chemically modified.

4. The electrophoresis gel sample loader of claim 1, wherein the porous sample holder is mounted with an adhesive.

5. The electrophoresis gel sample loader of claim 1, wherein the porous sample holder is mounted with mesh, linear fibers, or combinations thereof.

6. The electrophoresis gel sample loader of claim 1, further comprising a film.

7. The electrophoresis gel sample loader of claim 6, wherein the film comprises an aperture.

8. The electrophoresis gel sample loader of claim 7, wherein the porous sample holder is loaded with a sample via an end of the porous sample holder that is not covered with the film, the aperture, or both.

9. The electrophoresis gel sample loader of claim 1, wherein the backing material comprises an aperture.

10. The electrophoresis gel sample loader of claim 9, further comprising a barrier, wherein the barrier covers at least a portion of the aperture.

11. The electrophoresis gel sample loader of claim 1, further comprising a barrier plate disposed laterally to the porous sample holder.

12. The electrophoresis gel sample loader of claim 1, further comprising a porous strip, wherein the porous strip is loaded with ionic material.

13. An electrophoresis gel sample loader, comprising:
a loader comprising a backing material and a plurality of porous sample holders mounted on the backing material, wherein the porous sample holders retain a sample by absorption; and
a mounting layer comprising a plurality of dividers, wherein at least one divider is disposed laterally to a porous sample holder of the loader.

14. The electrophoresis gel sample loader of claim 13, wherein the porous sample holder comprises cotton cellulose fibers, sponge material, filter paper, foam, immobilized syntactics, hollow tubes, or combinations thereof.

15. The electrophoresis gel sample loader of claim 13, wherein at least one of the porous sample holders is chemically modified.

16. The electrophoresis gel sample loader of claim 13, wherein the porous sample holders are mounted with an adhesive.

17. The electrophoresis gel sample loader of claim 13, wherein the porous sample holders are mounted with mesh, linear fibers, or combinations thereof.

18. The electrophoresis gel sample loader of claim 13, wherein the backing material comprises an aperture.

19. The electrophoresis gel sample loader of claim 18, wherein a barrier covers at least a portion of the aperture.

20. The electrophoresis gel sample loader of claim 13, wherein the electrophoresis gel sample loader is prepared by pressing the loader and the mounting layer together.

21. The electrophoresis gel sample loader of claim 13, wherein the electrophoresis gel sample loader further comprises a porous strip, wherein the porous strip is loaded with ionic material.

22. A method of making an electrophoresis gel sample loader, comprising:
(A) securing a plurality of porous sample holders to a backing material to form a loader;
(B) providing a mounting layer comprising a plurality of dividers; and
(C) mounting the mounting layer to the loader to form the electrophoresis gel sample loader.

23. The method of claim 22, wherein step (C) further comprises mounting the mounting layer to provide a divider disposed lateral to each porous sample holder.

24. The method of claim 22, wherein step (C) is accomplished by pressing the mounting layer and the loader together.

25. A method of making an electrophoresis gel sample loader, comprising:
(A) adhering a barrier plate to a porous sample holder to provide a stack;
(B) cutting the stack to provide a slice, wherein the slice comprises a portion of the porous sample holder and at least a portion of the barrier plate; and
(C) adhering the slice to a backing material to provide the electrophoresis gel sample loader.

26. The method of claim 25, further comprising adhering the slice to a front barrier, wherein the front barrier is disposed on an opposite side of the slice from the backing material.

27. The method of claim 25, wherein the electrophoresis gel sample loader comprises a plurality of barrier plates and a plurality of porous sample holders.
